(19) United States
(12) Patent Application Publication
(10) Pub. No.: US 2005/0123022 A1
(43) Pub. Date: Jun. 9, 2005

(54) Temperature probe and thermometer having the same

(75) Inventors: Chu-Yih Yu, Taipei Hsien (TW); Hsiao-Yi Chang, Tali City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mesure Technology Co., Ltd.

(21) Appl. No.: 11/042,010

(22) Filed: Jan. 25, 2005

Related U.S. Application Data
(63) Continuation-in-part of application No. 10/274,220, filed on Oct. 18, 2002.

(51) Int. Cl. G01J 5/00

(52) U.S. Cl. 374/163; 374/208

(57) ABSTRACT

A temperature probe for use in a medical thermometer. The temperature probe includes a hollow tip member with an outer thermal contact surface. A thermal sensor is mounted on the inside of the outer thermal contact surface of the hollow tip member so as to sense the temperature of the thermal contact surface and produce a temperature signal. Wires are connected to the thermal sensor to pass the temperature signal. Specifically, the wires have an elastic expanding force, such that a part of the wires are directly contacted and against the inside of the outer thermal contact surface in a spiral form thereby.

### CROSS-REFERENCE TO RELATED APPLICATION

This application is a continuation-in-part of U.S. patent application Ser. No. 10/274,220, filed on Oct. 18, 2002, which is hereby incorporated by reference.

### BACKGROUND OF THE INVENTION

1. Field of the Invention

The invention relates to the field of thermometers. More particularly, the invention relates to the field of medical thermometers employing a temperature probe for measurement of a patient's temperature, although it is equally applicable to other temperature measurement fields.

2. Description of the Related Art

As disclosed in U.S. Pat. No. 4,183,248, electronic thermometers offer a great number of advantages over conventional glass and mercury thermometer for use in the health care field. Among the advantages of electronic thermometers are the elimination of sterilization procedure for glass thermometers, a digital temperature display to eliminate temperature reading errors, and higher accuracy and resolution, e.g., 1/10 degree Fahrenheit, being easily attainable with proper circuit design and calibration.

However, the major concern with regard to the electronic thermometers lays on their slow time response. This problem is incurred mainly because a thermometer probe represents a certain amount of mass and heat capacity, and when inserted from room temperature into a body cavity it cannot change temperature instantaneously, but instead approaches its final temperature more or less exponentially. It often requires over three minutes lag time before a final stabilized temperature is measured.

For the purpose of time response reduction, prior art techniques have included using a thermometer probe that has a metal tip for higher heat conductance. Additionally, U.S. Pat. No. 4,183,248 discloses an electronic thermometer which comprises two temperature sensors and a heater coil. The heater coil is used to thermally isolate the tip from the remainder of the probe, which eliminates long thermal time delays. The patent claims that a remarkable improvement of about 16 seconds measurement time is accomplished. U.S. Pat. No. 5,632,555 employs a heater to bring the probe tip to a specific temperature before it is applied to a patient. A microprocessor using a prediction algorithm is provided to determine the final temperature. This patent claims a measurement time of approximately 4 to 15 seconds. Nevertheless, these thermometers have some drawbacks such as high circuit complexity, high energy consumption and high production cost, since they have a built-in heater and/or expensive microprocessor.

To overcomes the aforementioned problems, U.S. Pat. No. 6,419,388 discloses an electronic medical thermometer which comprises a probe body having a metal tip to contact with a patient's tissue. The metal tip has a conical nose portion. The tip includes a temperature sensor mounted within the conical nose portion. The sensor thus generates a signal representing the temperature of the metal tip. Notably, the ratio of the metal tip's length to the metal tip's diameter is 3:1 at least. U.S. Pat. No. 6,419,388 claims that such a metal tip provides a small thermal capacity and a function like thermal isolation. This results in a measurement time of 20 to 30 seconds without a heater. However, transmission wires for the temperature signal, as shown in U.S. Pat. No. 6,419,388, are not fixed within the metal tip and exposed to air or gas such that the wires form a heat flow path which cannot be neglected. As a result, this takes the considerable measurement time.

### SUMMARY OF THE INVENTION

Accordingly, an embodiment of the invention provides a temperature probe including a hollow tip member with an outer thermal contact surface. A thermal sensor is mounted on the inside of the outer thermal contact surface of the hollow tip member, for sensing the temperature of the outer thermal contact surface and producing a temperature signal. Wires are connected to the thermal sensor for passing the temperature signal. The wires include elastic conductive material with an elastic expanding force. At least a portion of each wire is directly contacted and against the inside of the outer thermal contact surface in a spiral form, by the elastic expanding force.

Another embodiment of the invention provides a thermometer including a body member and a hollow tip member secured to the body member. The hollow tip member has an outer thermal contact surface. A thermal sensor is mounted on the inside of the outer thermal contact surface, for sensing the temperature of the outer thermal contact surface and producing a temperature signal. Wires are connected to the thermal sensor for passing the temperature signal. The wires include elastic conductive material with an elastic expanding force. At least a portion of each wire is directly contacted and against the inside of the outer thermal contact surface in a spiral form, by the elastic expanding force.

### BRIEF DESCRIPTION OF THE DRAWINGS

The present invention will be described by way of exemplary embodiments, but not limitations, illustrated in the accompanying drawings in which like references denote similar elements, and in which:

FIG. 1 is a cross-sectional view of a conventional thermometer;

FIG. 2 is a diagram illustrating heat flows in the conventional thermometer of FIG. 1;

FIG. 3 is a cross-sectional view of a first embodiment according to the invention; and

FIG. 4 is a cross-sectional view of a second embodiment according to the invention.

### DETAILED DESCRIPTION OF THE INVENTION

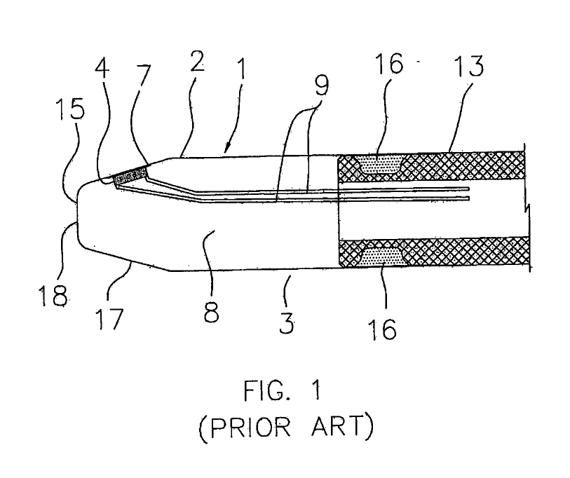

FIG. 1 illustrates a medical thermometer 1 according to a prior art. The thermometer 1 includes a metal tip 2 and a plastic probe body 13. The metal tip 2 is formed as a tubular part and attached to the plastic probe body 13 with glue 16. The metal tip 2 is made of thin metal and closed at the end 15. The end 15 has a conical portion 17 which is closed by a flat or rounded end portion 18. A temperature sensor 4 is mounted on the inner surface of the conical portion 17 by adhesive with good thermal conductivity. The remainder of the metal tip 2 is free from adhesive and preferably filled with air. Wires 9 connect the temperature sensor 4 to a circuit adapted to calculate and display the temperature measured by the sensor 4. The metal tip 2 also includes a contact surface 3 surrounding a hollow cavity 8. The contact surface 3 is brought in contact with flesh of a patient.

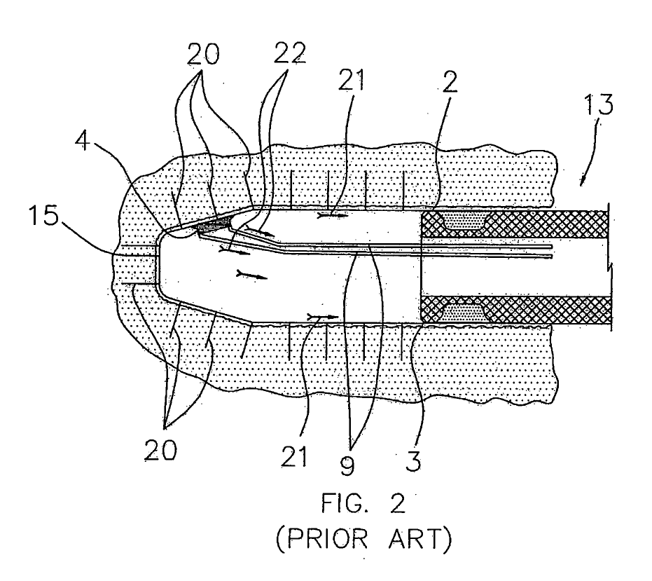

Referring to FIG. 2, the heat flow of the probe body 13 near the metal tip 2 is illustrated. Heat from the patient's flesh is transferred to the metal tip 2 as indicated by arrows 20. Meanwhile, heat flows through the metal tip 2 as shown by arrows 21 and also through the wires 9 as shown by arrows 22. The metal tip 2 is in contact with the patient's flesh over its entire length, the flesh surrounding the metal tip 2 functions like a distributing heater. Therefore, the heat flow 21 is very small and can be neglected. The metal tip 2 further serves as a thermal isolation between the end 15 of the metal tip 2 and the remaining part of the probe body 13.

The wires 9 without any treatment are exposed to the air within the metal tip 2, thus causing a considerable heat flow 22 that cannot be neglected. However, the prior art ignores this heat flow path intentionally. As a result, the thermometer 1 still takes a measurement time up to 30 seconds.

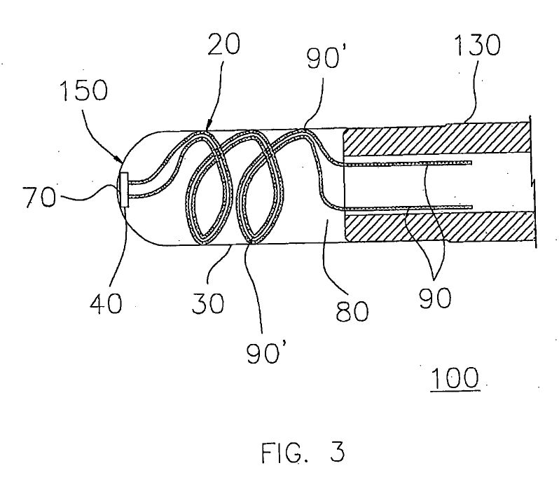

Referring to FIG. 3, a thermometer 100 of the invention is illustrated. The thermometer 100 includes a body member 130 and a temperature probe 150 secured to the body member 130. The temperature probe 150 includes a hollow tip member 20 with an outer thermal contact surface 30 surrounding a hollow cavity 80. A thermal sensor 40 is placed at the front end of the hollow tip member 20 and mounted on the inside of the outer thermal contact surface 30. The thermal sensor 40 senses the temperature of the outer thermal contact surface 30 and produces a temperature signal. Wires 90 are connected to the thermal sensor 40 to pass the temperature signal.

Preferably, the wires 90 include elastic conductive material with an elastic expanding force. At least a portion of each wire is directly contacted and against the inside of the outer thermal contact surface 30 in a spiral form, by the elastic expanding force as shown in FIG. 3.

In one example, the hollow tip member 150 includes a hollow cavity 80 filled with air in which the wires 90 near the front end of the hollow cavity 80 are directly contacted and against the inside of the outer thermal contact surface 30, thereby allowing the wires 90 to reach thermal equilibrium quickly.

In another example, the wires 90 have a fixing point 90′ which is mounted on the inside of the outer thermal contact surface 30, causing the wires 90 not to be easily moved.

In yet another example, the wires may include a wire made of elastic conductive material and a layer of deformable conductive material which covers the surface of the wire of elastic conductive material. For example, the elastic conductive material may include stainless steel and the deformable conductive material may include copper.

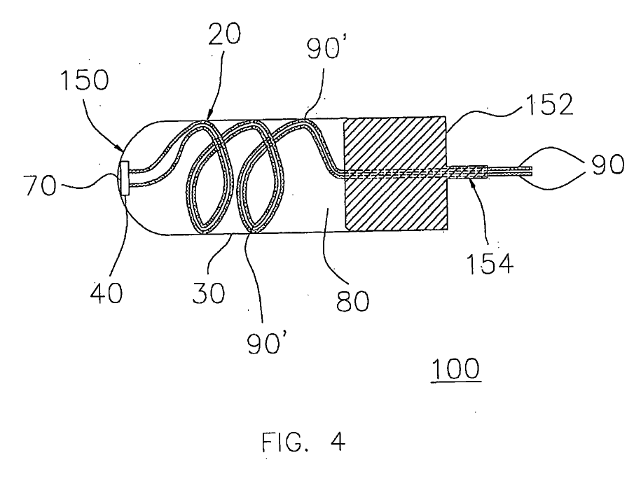

Referring to FIG. 4, in an exemplary embodiment of the invention, the rear end of the hollow tip member may be sealed by, for example, a seal member 152 such as a plastic, rubber or resin seal. Typically, an extension portion 154 extended from the seal member 152 is employed to pass the wires 90. In one example, the diameter of the extension portion 154 is nearly equal to the sum of the wires' diameter. In this way, the thermistor and the wires can reach thermal equilibrium very quickly because the unwanted air flow from the body member is prevented from the seal member 152 and the extension portion 154.

In the above-described embodiments, the hollow tip member 20 is preferably made of metal with high thermal conductivity, such as silver, platinum, or stainless steel. The hollow tip member 20 is made in the form of a tubular shape, and it has a domed, hemispherical or hemiellipsoid shaped end.

In another example, to enhance the conductive effect and add an elastic expanding force, the wires 90 are of copper covered steel wires, copper clad steel wires, or silver-plated copper clad steel wires. In this way, the thermistor and the wires can reach thermal equilibrium very quickly.

Typically, at least a portion of each wire is directly contacted to the inside of the outer thermal contact surface, not by glue layer, which, in turn, precludes the unwanted heat flow from the wires attached to the thermal sensor. Due to the absence of the glue layer as the heat mass in the hollow tip member, a certain amount of heat capacitance could be reduced. These allow the wires to approach an equilibrium temperature quickly as the outer thermal contact surface is heated, so that the thermal sensor reaches thermal equilibrium more rapidly.

Sometimes the patient's flesh may not wholly cover the rear end of the outer thermal contact surface. So the unwanted heat flow from the wires to the outer thermal contact surface may be happened. In this regard, preferably, only a portion of each wire near the front end of the hollow cavity 80 is contacted to the inside of the outer thermal contact surface in order to avoid exposure to the air within the hollow cavity. The other portions of the wires near the rear end of the hollow cavity may still expose to the air within the hollow cavity.

While the invention has been described by way of example and in terms of the preferred embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A temperature probe comprising:
a hollow tip member with an outer thermal contact surface;
a thermal sensor, mounted on the inside of the outer thermal contact surface of the hollow tip member, for sensing the temperature of the outer thermal contact surface and producing a temperature signal; and
wires, connected to the thermal sensor for passing the temperature signal;
wherein the wires comprise elastic conductive material with an elastic expanding force;
wherein at least a portion of each wire is directly contacted and against the inside of the outer thermal contact surface in a spiral form, by the elastic expanding force.

2. The temperature probe as recited in claim 1 wherein the hollow tip member comprises a hollow cavity filled with air in which the wires near the front end of the hollow cavity are directly contacted and against the inside of the outer thermal contact surface, thereby allowing the wires to reach thermal equilibrium quickly.

3. The temperature probe as recited in claim 2 wherein the wires have a fixing point which is mounted on the inside of the outer thermal contact surface, thereby causing the wires not to be easily moved.

4. The temperature probe as recited in claim 1 wherein the each wire comprises:
a wire of elastic conductive material; and
a layer of deformable conductive material which covers the surface of the wire of elastic conductive material.

5. The temperature probe as recited in claim 4 wherein the elastic conductive material comprises steel and the deformable conductive material comprises copper.

6. The temperature probe as recited in claim 2 wherein the wires near the rear end of the hollow cavity expose to the air within the hollow cavity.

7. The temperature probe as recited in claim 1, further comprising:
a seal member, adapted to seal the rear end of the hollow tip member; and
an extension portion, extended from the seal member for passing the wires.

8. A thermometer comprising:
a body member;
a hollow tip member, secured to the body member and having an outer thermal contact surface;
a thermal sensor, mounted on the inside of the outer thermal contact surface of the hollow tip member, for sensing the temperature of the outer thermal contact surface and producing a temperature signal; and
wires, connected to the thermal sensor for passing the temperature signal;
wherein the wires comprise elastic conductive material with an elastic expanding force;
wherein at least a portion of each wire is directly contacted and against the inside of the outer thermal contact surface in a spiral form, by the elastic expanding force.

9. The thermometer as recited in claim 8 wherein the wires are copper covered steel wires, copper clad steel wires, or silver-plated copper clad steel wires.
